(19) United States
(12) Patent Application Publication
(10) Pub. No.: US 2006/0013387 A1
(43) Pub. Date: Jan. 19, 2006

(54) Method and system for implementing KASUMI algorithm for accelerating cryptography in GSM/GPRS/EDGE compliant handsets

(76) Inventors: Ruei-Shiang Suen, Dublin, CA (US); Srinivasan Surendran, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 10/924,002

(22) Filed: Aug. 23, 2004

Related U.S. Application Data
(60) Provisional application No. 60/587,742, filed on Jul. 14, 2004.

(51) Int. Cl. H04L 9/28

(52) U.S. Cl. 380/28

(57) ABSTRACT

In a wireless communication system, a method and system for implementing a KASUMI algorithm for accelerating cryptography in GSM/GPRS/EDGE compliant handsets are provided. A pipelined implementation of the KASUMI algorithm may comprise a plurality of selectors, an FI function, an FO function, a first pipe register, a second pipe register, and an XOR operation. A selected first portion of the input data may be transferred to the first pipe register and a selected second portion to the second pipe register. A first output may be generated based on the transferred second portion of the input data while the transferred first portion of the input data may correspond to a second output. A plurality of control signals may control the inputs to the FO function and to the FL function according to whether the round of processing is an even round or an odd round.

### CROSS-REFERENCE TO RELATED APPLICATIONS/INCORPORATION BY REFERENCE

This patent application makes reference to, claims priority to and claims benefit from U.S. Provisional Patent Application Ser. No. 60/587,742 (Attorney Docket No. 15600US01), entitled “Method and System for Implementing FI Function in KASUMI Algorithm for Accelerating Cryptography in GSM/GPRS/EDGE Compliant Handsets,” filed on Jul. 14, 2004.

This application makes reference to:

U.S. application Ser. No. ______ (Attorney Docket No. 15600US02) filed Aug. 23, 2004;

U.S. application Ser. No. ______ (Attorney Docket No. 15999US01) filed Aug. 23, 2004;

U.S. application Ser. No. ______ (Attorney Docket No. 16057US01) filed Aug. 23, 2004; and

U.S. application Ser. No. ______ (Attorney Docket No. 16058US01) filed Aug. 23, 2004.

The above stated applications are hereby incorporated herein by reference in their entirety.

### FIELD OF THE INVENTION

Certain embodiments of the invention relate to cryptography. More specifically, certain embodiments of the invention relate to a method and system for implementing a KASUMI algorithm for accelerating cryptography in GSM/GPRS/EDGE compliant handsets.

### BACKGROUND OF THE INVENTION

In wireless communication systems, the ability to provide secure and confidential transmissions becomes a highly important task as these systems move towards the next generation of data services. Secure wireless transmissions may be achieved by applying confidentiality and integrity algorithms to encrypt the information to be transmitted. For example, the Global System for Mobile Communication (GSM) uses the A5 algorithm to encrypt both voice and data and the General Packet Radio Service (GPRS) uses the GEA algorithm to provide packet data encryption capabilities in GSM systems. The next generation of data services leading to the so-called third generation (3G) is built on GPRS and is known as the Enhanced Data rate for GSM Evolution (EDGE). Encryption in EDGE systems may be performed by either the A5 algorithm or the GEA algorithm depending on the application. One particular EDGE application is the Enhanced Circuit Switch Data (ECSD).

There are three variants of the A5 algorithm: A5/1, A5/2, and A5/3. The specifications for the A5/1 and the A5/2 variants are confidential while the specifications for the A5/3 variant are provided by publicly available technical specifications developed by the 3rd Generation Partnership Project (3GPP). Similarly, three variants exist for the GEA algorithm: GEA1, GEA2, and GEA3. The specifications for the GEA3 variant are also part of the publicly available 3GPP technical specifications while specifications for the GEA1 and GEA2 variants are confidential. The technical specifications provided by the 3GPP describe the requirements for the A5/3 and the GEA3 algorithms but do not provide a description of their implementation.

Variants of the A5 and GEA algorithms are based on the KASUMI algorithm which is also specified by the 3GPP. The KASUMI algorithm is a symmetric block cipher with a Feistel structure or Feistel network that produces a 64-bit output from a 64-bit input under the control of a 128-bit key. Feistel networks and similar constructions are product ciphers and may combine multiple rounds of repeated operations, for example, bit-shuffling functions, simple non-linear functions, and/or linear mixing operations. The bit-shuffling functions may be performed by permutation boxes or P-boxes. The simple non-linear functions may be performed by substitution boxes or S-boxes. The linear mixing may be performed using XOR operations. The 3GPP standards further specify three additional variants of the A5/3 algorithm: an A5/3 variant for GSM, an A5/3 variant for ECSD, and a GEA3 variant for GPRS (including Enhanced GPRS or EGPRS).

The A5/3 variant utilizes three algorithms and each of these algorithms uses the KAZUMI algorithm as a keystream generator in an Output Feedback Mode (OFB). All three algorithms may be specified in terms of a general-purpose keystream function KGCORE. The individual encryption algorithms for GSM, GPRS and ECSD may be defined by mapping their corresponding inputs to KGCORE function inputs, and mapping KGCORE function outputs to outputs of each of the individual encryption algorithms. The heart of the KGCORE function is the KASUMI cipher block, and this cipher block may be used to implement both the A5/3 and GEA3 algorithms.

Implementing the A5/3 algorithm directly in an A5/3 algorithm block or in a KGCORE function block, however, may require ciphering architectures that provide fast and efficient execution in order to meet the transmission rates, size and cost constraints required by next generation data services and mobile systems. A similar requirement may be needed when implementing the GEA3 algorithm directly in a GEA3 algorithm block or in a KGCORE function block. Because of their complexity, implementing these algorithms in embedded software to be executed on a general purpose processor on a system-on-chip (SOC) or on a digital signal processor (DSP), may not provide the speed or efficiency necessary for fast secure transmissions in a wireless communication network. Moreover, these processors may need to share some of their processing or computing capacity with other applications needed for data processing. The development of cost effective integrated circuits (IC) capable of accelerating the encryption and decryption speed of the A5/3 algorithm and the GEA3 algorithm is necessary for the deployment of next generation data services.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for implementing KASUMI algorithm for accelerating cryptography in GSM/GPRS/EDGE compliant handsets. Aspects of the method may comprise selecting via a first selector or multiplexer, a first portion of input data and transferring the first portion of input data to a first pipe register. A second selector may select a second portion of input data and may transfer the second portion of input data to a second pipe register. A third selector may be enabled to transfer the transferred first portion of the input data to an FL function for processing during odd rounds or to transfer an output of an FO function to the FL function for processing during even rounds. A fourth selector may be enabled to transfer the transferred first portion of the input data to the FO function for processing during even rounds or to transfer an output of the FL function to the FO function for processing during odd rounds. A fifth selector may be enabled to select the output of the FO function during odd rounds or the output of the FL function during even rounds.

The method may also comprise generating a first output signal by XORing an output of the fifth selector with the transferred second portion of the input data. The first output signal may be transferred to an input of the first selector, while a second output signal may be transferred to an input of said second selector, wherein the second output signal is the transferred second portion of the input data.

The first selector and the second selector may be controlled via a first control signal and a second control signal. The first control signal may be used to clock the first portion of the input data and the second portion of the input data into the first pipe register and the second pipe register respectively. The second control signal may be generated when the output of the FO function is available for processing. The third selector, the fourth selector and the fifth selector may be controlled via a third control signal, wherein the third control signal is based on whether the round is odd or even. A first set of subkeys may be transferred to the FL function for processing with an output of the third selector, while a second set of subkeys may be transferred to the FO function for processing with an output of the fourth selector.

Aspects of the system may comprise a first selector that selects a first portion of input data and a second selector that selects a second portion of input data. A first pipe register may be provided that stores the first portion of the input data after being transferred from the first selector and a second pipe register that stores the second portion of the input data after being transferred from the second selector. A third selector may also be provided that transfers the transferred first portion of the input data to an FL function for processing during odd rounds or transfers an output of an FO function to the FL function for processing during even rounds. A fourth selector may also be provided that transfers the transferred first portion of the input data to the FO function for processing during even rounds or transfers an output of the FL function to the FO function for processing during odd rounds. Moreover, a fifth selector may be provided that selects the output of the FO function during odd rounds or selects the output of the FL function during even rounds.

The system may also comprise an XOR gate that generates a first output signal by XORing an output of the fifth selector with the transferred second portion of the input data. Circuitry may be provided for transferring the first output signal to an input of the first selector and for transferring a second output signal to an input of the second selector, wherein the second output signal is the transferred second portion of the input data.

The first selector and the second selector may be controlled via a first control signal and a second control signal. Circuitry may be provided for clocking the first portion of the input data and the second portion of said input data into the first pipe register and into the second pipe register respectively using the first control signal. Circuitry may be provided for generating the second control signal, wherein the second control signal is generated when the output of the FO function is available for processing. Circuitry may be provided to generate a third control signal based on whether the round is odd or even and the third selector, the fourth selector and the fifth selector may be controlled via the third control signal. Moreover, circuitry maybe provided for transferring a first set of subkeys to the FL function for processing with an output of the third selector and for transferring a second set of subkeys to the FO function for processing with an output of the fourth selector.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary A5/3 data encryption system for GSM communications, as disclosed in 3rd Generation Partnership Project, Technical Specification Group Services and System Aspects, 3G Security, Specification of the A5/3 Encryption Algorithms for GSM and ECSD, and the GEA3 Encryption Algorithm for GPRS, Document 1, A5/3 and GEA3 Specifications, Release 6 (3GPP TS 55.216 V6.1.0, 2002-12).

FIG. 1B is a block diagram of an exemplary GEA3 data encryption system for GPRS/EGPRS communications, which may be utilized in connection with an embodiment of the invention.

FIG. 2A is a diagram of an exemplary set-up for a KGCORE block to operate as a GSM A5/3 keystream generator function, which may be utilized in connection with an embodiment of the invention.

FIG. 2B is a diagram of an exemplary set-up for a KGCORE block to operate as a GEA3 keystream generator function, which may be utilized in connection with an embodiment of the invention.

FIG. 3 is a flow diagram that illustrates an eight-round KASUMI algorithm, as disclosed in 3rd Generation Partnership Project, Technical Specification Group Services and System Aspects, Specification of the 3GPP Confidentiality and Integrity Algorithms, Kasumi Specification, Release 5 (3GPP TS 35.202 V5.0.0, 2002-06).

FIG. 4 is a block diagram of an exemplary system for performing the eight-round KASUMI algorithm, in accordance with an embodiment of the invention.

FIG. 4B is a flow diagram that illustrates the operation of an exemplary KASUMI algorithm system, in accordance with an embodiment of the invention.

FIG. 5 is a circuit diagram of an exemplary implementation of an FL function, which may be utilized in connection with an embodiment of the invention.

FIG. 6 is a flow diagram that illustrates a three-round FO function, which may be utilized in connection with an embodiment of the invention.

FIG. 7 is a block diagram of an exemplary implementation of the FO function, in accordance with an embodiment of the invention.

FIG. 8 is a flow diagram that illustrates a four-round FI function, which may be utilized in connection with an embodiment of the invention.

FIG. 9 is a circuit diagram of an exemplary implementation of the FI function, in accordance with an embodiment of the invention.

FIG. 10 illustrates the round subkeys generated by a key scheduler from the arrays of subkeys Kⱼ and Kⱼ′ for the eight-round KASUMI algorithm, in accordance with an embodiment of the invention.

### DETAILED DESCRIPTION OF THE INVENTION

Certain embodiments of the invention may be found in a method and system for implementing the KASUMI algorithm for accelerating cryptography in GSM/GPRS/EDGE compliant handsets. A pipelined system for efficiently implementing the KASUMI algorithm may comprise a plurality of multiplexers or selectors, an FL function, an FO function, a first register, a second register, and an XOR operation. A plurality of signals may be generated to control the processing flow and operation of the pipelined system. This pipelined approach to the KASUMI algorithm provides a cost effective and efficient implementation that accelerates cryptographic operations in GSM/GPRS/EDGE compliant handsets.

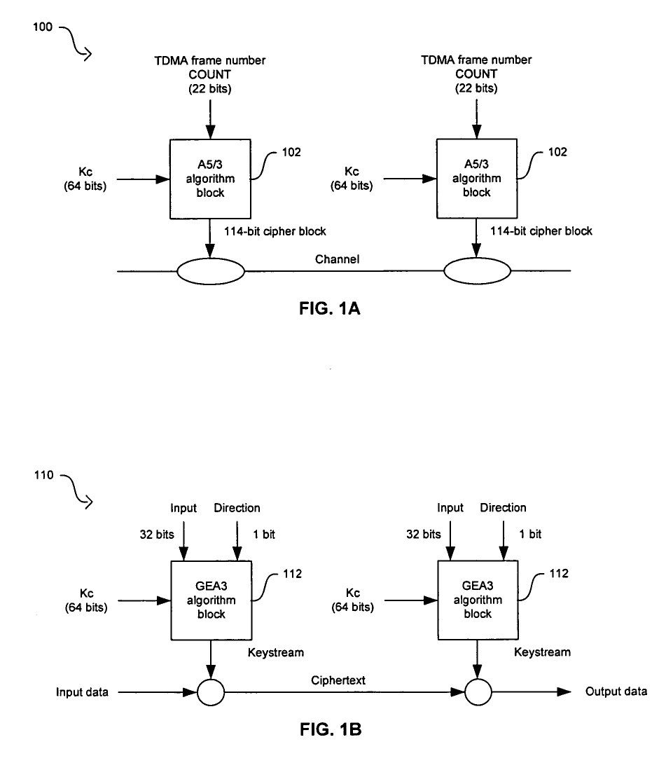

FIG. 1A is a block diagram of an exemplary A5/3 data encryption system for GSM communications, as disclosed in 3rd Generation Partnership Project, Technical Specification Group Services and System Aspects, 3G Security, Specification of the A5/3 Encryption Algorithms for GSM and ECSD, and the GEA3 Encryption Algorithm for GPRS, Document 1, A5/3 and GEA3 Specifications, Release 6 (3GPP TS 55.216 V6.1.0, 2002-12). Referring to FIG. 1A, the GSM encryption system 100 may comprise a plurality of A5/3 algorithm blocks 102. The A5/3 algorithm block 102 may be used for encryption and/or decryption and may be communicatively coupled to a wireless communication channel. The A5/3 algorithm block 102 may be used to encrypt data transmitted on a DCCH (Dedicated Control Channel) and a TCH (Traffic Channel). The inputs to the A5/3 algorithm block 102 may comprise a 64-bit privacy key, Kc, and a TDMA frame number COUNT. The COUNT parameter is 22-bits wide and each frame represented by the COUNT parameter is approximately 4.6 ms in duration. The COUNT parameter may take on decimal values from 0 to 4194304, and may have a repetition time of about 5 hours, which is close to the interval of a GSM hyper frame. For each frame, two outputs may be generated by the A5/3 algorithm block 102: BLOCK1 and BLOCK2. Because of the symmetry of the A5/3 stream cipher, the BLOCK1 output may be used, for example, for encryption by a Base Station (BS) and for decryption by a Mobile Station (MS) while the BLOCK2 output may be used for encryption by the MS and for decryption by the BS. In GSM mode, the BLOCK1 output and the BLOCK2 output are 114 bits wide each. In EDGE mode, the BLOCK1 output and the BLOCK2 output are 348 bits wide each.

FIG. 1B is a block diagram of an exemplary GEA3 data encryption system for GPRS/EGPRS communications, which may be utilized in connection with an embodiment of the invention. Referring to FIG. 1B, the GPRS/EGPRS encryption system 110 may comprise a plurality of GEA3 algorithm blocks 112. The GEA3 algorithm block 112 may be used for data encryption in GPRS and may also be used in EGPRS which achieves higher data rates through an 8 Phase Shift Key (PSK) modulation scheme. A Logical Link Control (LLC) layer is the lowest protocol layer that is common to both an MS and a Serving GPRS Support Node (SGSN). As a result, the GEA3 encryption may take place on the LLC layer.

When ciphering is initiated, a higher layer entity, for example, Layer 3, may provide the LLC layer with the 64-bit key, K_{C}, which may be used as an input to the GEA3 algorithm block 112. The LLC layer may also provide the GEA3 algorithm block 112 with a 32-bit INPUT parameter and a 1-bit DIRECTION parameter. The GEA3 algorithm block 112 may also be provided with the number of octets of OUTPUT keystream data required. The DIRECTION parameter may specify whether the current keystream will be used for upstream or downstream communication, as both directions use a different keystream. The INPUT parameter may be used so that each LLC frame is ciphered with a different segment of the keystream. This parameter is calculated from the LLC frame number, a frame counter, and a value supplied by the SGSN called the Input Offset Value (IOV).

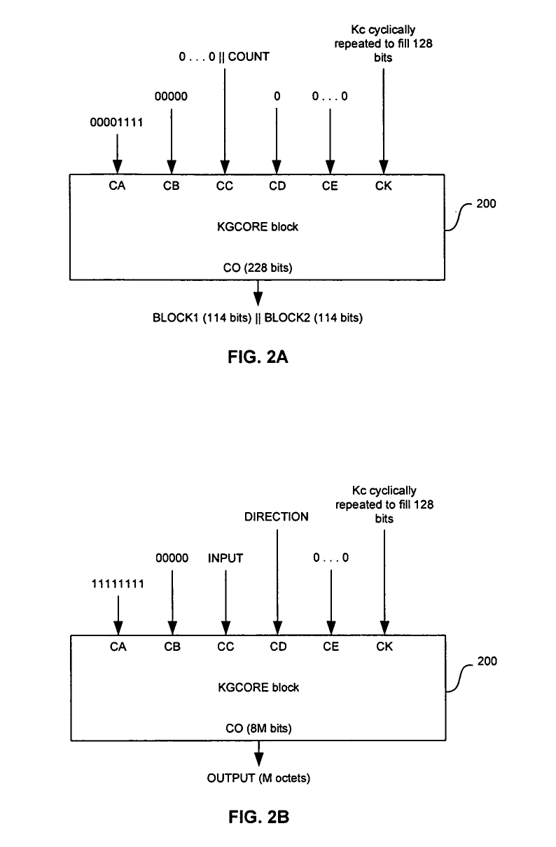

FIG. 2A is a diagram of an exemplary set-up for a KGCORE function block to operate as an A5/3 keystream generator function, which may be utilized in connection with an embodiment of the invention. Referring to FIG. 2A, the KGCORE function block 200 may receive as inputs a CA parameter, a CB parameter, a CC parameter, a CD parameter, a CE parameter, a CK parameter, and a CL parameter. The KGCORE function block 200 may produce an output defined by a CO parameter. The function or operation of the KGCORE function block 200 may be defined by the input parameters. The values shown in FIG. 2A may be used to map the GSM A5/3 algorithm inputs and outputs to the inputs and outputs of the KGCORE function. For example, the CL parameter specifies the number of output bits to produce, which for GSM applications is 128. In this case, the outputs CO[0] to CO[113] of the KGCORE function block 200 may map to the outputs BLOCK1[0] to BLOCK1[113] of the A5/3 algorithm. Similarly, the outputs CO[114] to CO[227] of the KGCORE function block 200 may map to the outputs BLOCK2[0] to BLOCK2[113] of the A5/3 algorithm.

FIG. 2B is a diagram of an exemplary set-up for a KGCORE function block to operate as a GEA3 keystream generator function, which may be utilized in connection with an embodiment of the invention. Referring to FIG. 2B, the KGCORE function block 200 may be used to map the GPRS GEA3 algorithm inputs and outputs to the inputs and outputs of the KGCORE function. For example, the CL parameter specifies the number M of octets of output required, producing a total of 8M bits of output. In this case, the outputs CO[0] to CO[8M−1] of the KGCORE function block 200 may map to the outputs of the GEA3 algorithm by OUTPUT[i]=CO[8i] . . . CO[8i+7], where 0≦i≦M−1.

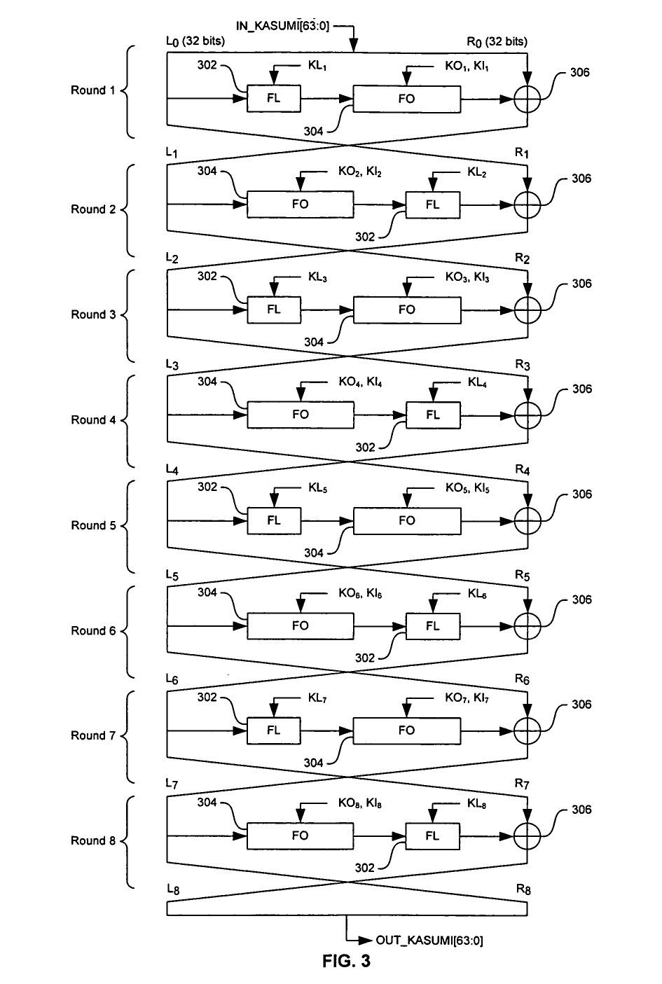

FIG. 3 is a flow diagram that illustrates an eight-round KASUMI algorithm, as disclosed in 3rd Generation Partnership Project, Technical Specification Group Services and System Aspects, Specification of the 3GPP Confidentiality and Integrity Algorithms, Kasumi Specification, Release 5 (3GPP TS 35.202 V5.0.0, 2002-06). Referring to FIG. 3, the eight-round KASUMI algorithm operates on a 64-bit data input (IN_KASUMI[63:0]) under the control of a 128-bit key to produce a 64-bit output (OUT_KASUMI[63:0]). Each round of the KASUMI algorithm comprises an FL function 302, an FO function 304, and a bitwise XOR operation 306. For each round of the KASUMI algorithm, the FL function 302 may utilize a subkey KL while the FO function 304 may utilize a subkey KO and a subkey KI. The FL function 302 may comprise suitable logic, circuitry, and/or code that may be adapted to perform the FL function of the KASUMI algorithm as specified by the 3GPP technical specification. The FO function 304 may comprise suitable logic, circuitry, and/or code that may be adapted to perform the FO function of the KASUMI algorithm as specified by the 3GPP technical specification. The bitwise XOR operation 306 may comprise suitable logic, circuitry, and/or code that may be adapted to perform a 32-bit bitwise XOR operation on its inputs.

In operation, the input IN_KASUMI[63:0] may be divided into two 32-bit strings L₀ and R₀. The input IN_KASUMI[63:0]=L₀∥R₀, where the ∥ operation represents concatenation. The 32-bit strings inputs for each round of the KASUMI algorithm may be defined as Rᵢ=Lᵢ₋₁ and Lᵢ=Rᵢ₋₁⊕fᵢ(Lᵢ₋₁, RKᵢ), where 1≦i≦8, where fᵢ( ) denotes a general i^{th} round function with Lᵢ₋₁ and round key RKᵢ as inputs, and the ⊕ operation corresponds to the bitwise XOR operation 306. The result of the KASUMI algorithm is a 64-bit string output (OUT_KASUMI[63:0]=L₈∥R₈) produced at the end of the eighth round.

The function fᵢ( ) may take a 32-bit input and may return a 32-bit output under the control of the i^{th} round key RKᵢ, where the i^{th} round key RKᵢ comprises the subkey triplet KLᵢ, KOᵢ, and KIᵢ. The function fᵢ( ) comprises the FL function 302 and the FO function 304 with associated subkeys KLᵢ used with the FL function 302 and subkeys KOᵢ and KIᵢ used with the FO function 304. The fᵢ( ) function may have two different forms depending on whether it is an even round or an odd round. For rounds 1, 3, 5 and 7 the fᵢ( ) function may be defined as fᵢ(Lᵢ₋₁,RKᵢ)=FO(FL(Lᵢ₋₁, KLᵢ), KOᵢ, KIᵢ ) and for rounds 2, 4, 6 and 8 it may be defined as fᵢ(Lᵢ₋₁,RKᵢ)=FL(FO(Lᵢ₋₁, KOᵢ, KIᵢ), KLᵢ). That is, for odd rounds, the round data is passed through the FL function 302 first and then through the FO function 304, while for even rounds, data is passed through the FO function 304 first and then through the FL function 302. The appropriate round key RKᵢ for the i^{th} round of the KASUMI algorithm, comprising the subkey triplet of KLᵢ, KOᵢ, and KIᵢ, may be generated by a Key scheduler, for example.

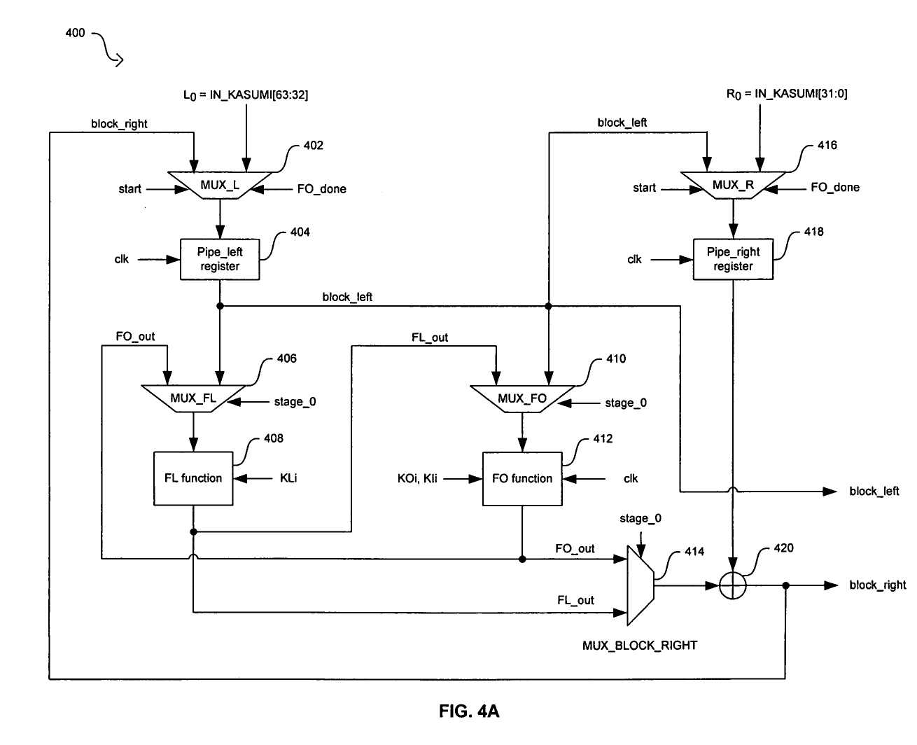

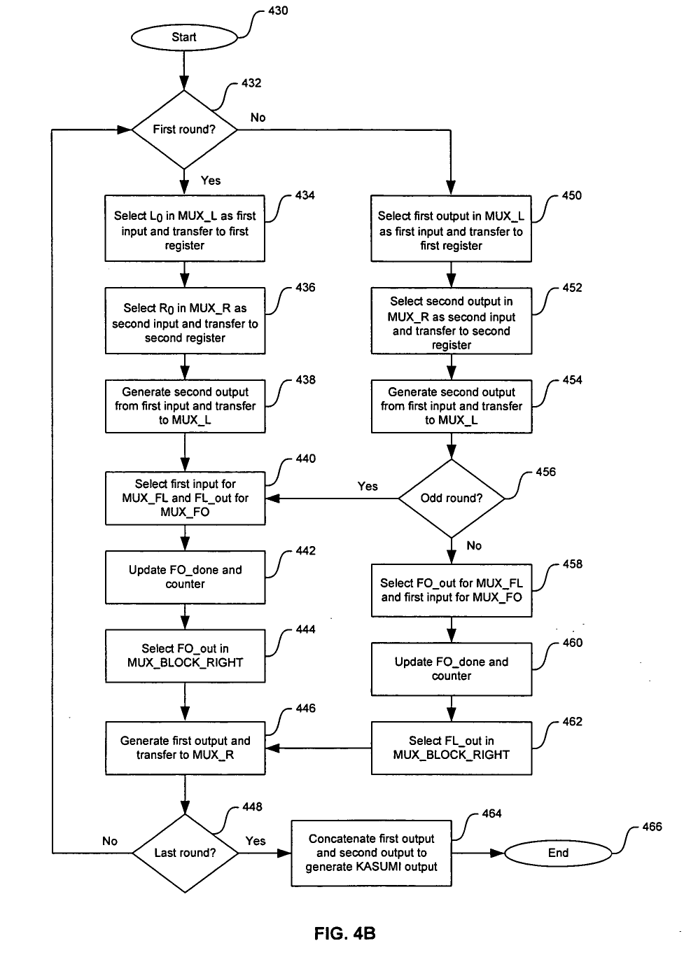

FIG. 4 is a block diagram of an exemplary system for performing the eight-round KASUMI algorithm, in accordance with an embodiment of the invention. Referring to FIG. 4, the exemplary system for performing the eight-round KASUMI algorithm may comprise a MUX_L multiplexer 402, a pipe_left register 404, a MUX_FL multiplexer 406, an FL function 408, a MUX_FO multiplexer 410, an FO function 412, a MUX_BLOCK_RIGHT multiplexer 414, a MUX_R multiplexer 416, a pipe_right register 418, and a bitwise XOR operation 420.

The MUX_L multiplexer 402 may comprise suitable logic, circuitry, and/or code that may be adapted to select between the 32 most significant bits (MSB) of the input signal (L₀=IN_KASUMI[63:32]) and the block_right signal generated in a previous round of the KASUMI algorithm. The selection may be controlled by a start signal and an FO_done signal generated by the FO function 412. The pipe_left register 404 may comprise suitable logic, circuitry, and/or code that may be adapted to store the output of the MUX_L multiplexer 402 based on an input clock (clk) signal. The pipe_left register 404 may produce an output signal denoted as block_left. The MUX_FL multiplexer 406 may comprise suitable logic, circuitry, and/or code that may be adapted to select between the output of the pipe_left register 404 and an FO_out signal generated by the FO function 412. The selection may be controlled by a stage_0 signal. The FL function 408 may comprise suitable logic, circuitry, and/or code that may be adapted to perform the FL function in the KASUMI algorithm as specified by the 3GPP technical specification. The FL function 408 may produce an FL_out signal.

The MUX_FO multiplexer 410 may comprise suitable logic, circuitry, and/or code that may be adapted to select between the output of the pipe_left register 404 and the FL_out signal generated by the FL function 408. The selection may be controlled by the stage_0 signal. The FO function 412 may comprise suitable logic, circuitry, and/or code that may be adapted to perform the FO function in the KASUMI algorithm as specified by the 3GPP technical specification. The FO function 412 may produce an FO_out signal.

The MUX_R multiplexer 416 may comprise suitable logic, circuitry, and/or code that may be adapted to select between the 32 least significant bits (LSB) of the input signal R₀=IN_KASUMI[31:0] and the block_left signal generated in a previous round of the KASUMI algorithm. The selection may be controlled by a start signal and an FO_done signal generated by the FO function 412. The pipe_right register 418 may comprise suitable logic, circuitry, and/or code that may be adapted to store the output of the MUX_R multiplexer 416 based on the a clock (clk) signal.

The MUX_BLOCK_RIGHT multiplexer 414 may comprise suitable logic, circuitry, and/or code that may be adapted to select between the FO_out signal from the FO function 412 and the FL_out signal from the FL function 408. The selection may be controlled by the stage_0 signal. The bitwise XOR operation 420 may comprise suitable logic, circuitry, and/or code that may be adapted to XOR the output of the MUX_BLOCK_RIGHT multiplexer 414 and the output of the pipe_right register 418. The bitwise XOR operation 420 may produce the block_right signal.

In operation, the start signal is an input to KASUMI algorithm system 400 and is held high for one clock cycle indicating the start of the KASUMI algorithm operation. The start signal may be used to control the MUX_L multiplexer 402 and the MUX_R multiplexer 416, and may also be used to clock input data IN_KASUMI[63:32], and IN_KASUMI[31:0] to the pipe_left register 404 and the pipe_right register 418 respectively. The FO_done is another control signal utilized to control the MUX_L multiplexer 402 and the MUX_R multiplexer 416, and may be used to clock the block_right signal and the block_left signal to the pipe_left register 404 and the pipe_right register 418 respectively.

The FO_done signal may be utilized to update a counter such as a 3-bit stage counter that keeps track of the number of rounds. The Least Significant Bit (LSB) of the stage counter may be the stage_0 signal, which may be used to keep track of when a round in the KASUMI algorithm is even or odd. For example, when the stage_0 signal is 0 it is an odd round and when it is 1 it is an even round. The stage_0 signal may be used to control the MUX_L multiplexer 402 and the MUX_R multiplexer 416, which selects the inputs to the FL function 408 and the FO function 412 respectively. In instances when the round is odd, that is, the stage_0 signal is 0, the inputs to the FL function 408 and the FO function 412 are the output of the pipe_left register 404 and the FL_out signal respectively. In instances when the round is even, the inputs to the FL function 408 and the FO function 412 are the output of the FO_out signal and the output of the pipe_left register 404 respectively.

The stage_0 signal may also be utilized to control the MUX_BLOCK_RIGHT multiplexer 414. For example, when the stage_0 signal is logic 0, the FO_out signal may be XORed with the output of the pipe_right register 418 to generate the block_right signal. When the stage_0 signal is logic 1, the FL_out signal may be XORed with the output of the pipe_right register 418 to generate the block_right signal. The block_left signal and the block_right signal may be fed back to the MUX_R multiplexer 416 and the MUX_L multiplexer 402 respectively. The output signal OUT_KASUMI[63:0] of the KASUMI algorithm system 400 may be a concatenation of the block_right signal and the block_left signal and may be registered when the stage counter indicates completion of eight rounds.

FIG. 4B is a flow diagram that illustrates the operation of an exemplary KASUMI algorithm system, in accordance with an embodiment of the invention. Referring to FIG. 4B, in start step 430, a counter that indicates the current round of the KASUMI algorithm may be set to indicate that the current round of processing is the first round of the eight-round KASUMI algorithm. In step 432, the KASUMI algorithm system 400 may determine whether the current round is the first round of operation based on the current values of the start signal, the FO_done signal, and/or the stage_0 signal. When the current round is the first round of operation, the KASUMI algorithm system 400 may proceed to step 434. In step 434, the start signal may be utilized to select as a first input data from a first multiplexer or selector, MUX_L multiplexer 402, an input data L₀=IN_KASUMI[63:32] by clocking the input data L₀ into the MUX_L multiplexer 402. The first input data from the MUX_L multiplexer 402 may then be transferred into a first register, pipe_left register 404. In step 436, the start signal may be utilized to select as a second input data from a second multiplexer or selector, MUX_R multiplexer 416, an input data R₀=IN_KASUMI[31:0] by clocking the input data R₀ into the MUX_R multiplexer 416. The second input data from the MUX_R multiplexer 416 may then be transferred into a second register, pipe_right register 418.

In step 438, the first input data from the MUX_L multiplexer 402 may be clocked from the first register and assigned as a second output of the first round of operation. The first input data may also be transferred to an input of the MUX_R multiplexer 416 for the next round of processing. In step 440, the stage_0 signal may be utilized to select the first input data in a third selector, MUX_FL multiplexer 406, and also to select the output of the FL function 408, FL_out, in a fourth selector, MUX_FL multiplexer 410. These selections produce a processing chain for the first round where the first input data is provided as an input to the FL function 408 and the output of the FL function 408 is provided as an input to the FO function 412, as shown in FIG. 3. In step 442, when the FO function 412 completes processing and generates the FO_out signal, the FO_done signal may be generated to indicate the completion of processing and the counter may also be updated to correspond to the next round of processing, for example, the second round of the KASUMI algorithm.

In step 444, the FO_out signal may be selected in the first round of operation by a fifth selector, MUX_BLOCK_RIGHT multiplexer 414, to be XORed in the bitwise XOR operation 420 with the second input data clocked from the second register. In step 446, the output of the bitwise XOR operation 420 may be assigned as the first output of the first round of operation and may be transferred to an input of the MUX_L multiplexer 402 for the next round of processing. In step 448, the KASUMI algorithm system 400 may determine whether the current round of operation is the eight and last round of operation. When the current round of operation is not the last round, then the KASUMI algorithm system 400 may proceed to step 432.

Returning to step 432, when the current round of operation is not the first round, the KASUMI algorithm system 400 may then proceed to step 450. In step 450, the FO_done signal may be utilized to select as the first input data for the current round from the MUX_L multiplexer 402 the first output from the previous round of operation by clocking the first output into the MUX_L multiplexer 402. The first input data from the MUX_L multiplexer 402 may then be transferred to the first register, pipe_left register 404, for storage. In step 452, the FO_done signal may be utilized to select as the second input data for the current round from the MUX_R multiplexer 416 the second output from the previous round of operation by clocking the second output into the MUX_R multiplexer 416. The second input data from the MUX_R multiplexer 416 may then be transferred to the second register, pipe_right register 418, for storage.

In step 454, the first input data from the MUX_L multiplexer 402 may be clocked from the first register and assigned as a second output of the current round of operation. The first input data may also be transferred to an input of the MUX_R multiplexer 416 for the next round of processing. In step 456, the KASUMI algorithm system 400 may determine whether the current round is even or odd. In this regard, rounds 1, 3, 5, and 7 are odd rounds, and rounds 2, 4, 6, and 8 are even rounds. When the current round is odd, the KASUMI algorithm system 400 may proceed to step 440 and perform the current odd round of processing based on the processing chain where the first input data is provided as an input to the FL function 408 and the output of the FL function 408 is provided as an input to the FO function 412, as shown in FIG. 3. When the current round is even, the KASUMI algorithm system 400 may proceed to step 458.

In step 458, the stage_0 signal may be utilized to select the output of the FO function 412, FO_out, in the MUX_FL multiplexer 406 and also to select the first input data in the MUX_FL multiplexer 410. These selections produce a processing chain for the current even round of processing where the first input data is provided as an input to the FO function 412 and the output of the FO function 412 is provided as an input to the FL function 406, as shown in FIG. 3. In step 460, when the FO function 412 completes processing and generates the FO_out signal, the FO_done signal may be updated to indicate the completion of processing and the counter may also be updated to correspond to the next round of processing. In step 462, the FL out signal may be selected in the current even round of operation by the MUX_BLOCK_RIGHT multiplexer 414 to be XORed in the bitwise XOR operation 420 with the second input data clocked from the second register. After step 462, the KASUMI algorithm system 400 may proceed to step 446 where the output of the bitwise XOR operation 420 may be assigned as the first output of the current even round and may then be transferred to an input of the MUX_L multiplexer 402 for the next round of processing.

Returning to step 448, when the current round of operation is the last round, then the KASUMI algorithm system 400 may proceed to step 464. In step 464, the first output and the second output of the last round of processing may be concatenated to generate the KASUMI algorithm output. In the end step 466, the KASUMI algorithm system 400 may generate a signal to indicate that the KASUMI operation has completed and may also update the round counter in preparation for the next time a keystream generator function block may execute the KASUMI algorithm.

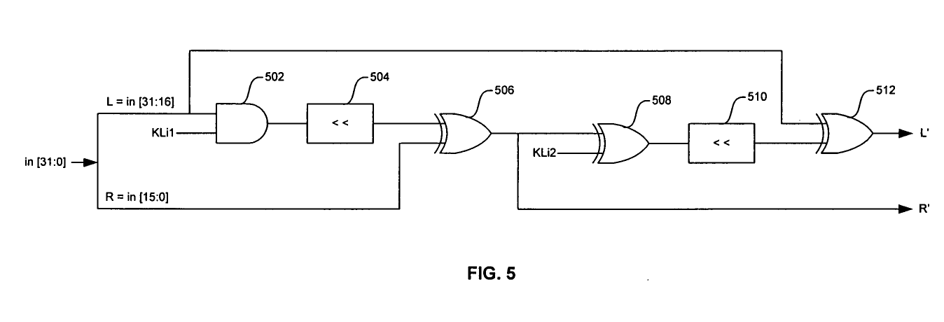

FIG. 5 is a circuit diagram of an exemplary implementation of an FL function, which may be utilized in connection with an embodiment of the invention. According to FIG. 5, the FL function 408 in FIG. 4 may comprise an AND gate 502, a first circular 1-bit shifter 504, a first XOR gate 506, a second XOR gate 508, a second circular 1-bit shifter 510, and a third XOR gate 512.

In operation, the FL function 408 may take 32-bits of input data and a 32-bit subkey KLᵢ and return 32-bits of output data. The subkey may be split into two 16-bit subkeys, KL_{i,1} and KL_{i,2} where KLᵢ=KL_{i,1}∥KL_{i,2}, where ∥ represents concatenation operation. The 32-bit wide input to the FL function 408, in[31:0], may be divided into a 16 MSB signal L, where L=in[31:16], and a 16 LSB signal R, where R=in[15:0], where I=L∥R. The outputs of the FL function 408 may be defined as R′=R⊕ROL(L∩KL_{i,1}) and L′=L⊕ROL(R′∪KL_{i,2}), where ROL is a left circular rotation of the operand by one bit; ∩ is a bitwise AND operation; ∪ is a bitwise OR operation; and ⊕ is bitwise XOR operation.

The signal L and the subkey KL_{i,1} may be utilized as inputs to the AND gate 502. The signal L may also be utilized as input to the third XOR gate 512. The output of the AND gate 502 may be bit shifted by the first circular 1-bit shifter 504. The output of the first circular 1-bit shifter 504 and the signal R may be utilized as input to the first XOR gate 506. The output of the first XOR gate 506 and the subkey KL_{i,2} may be used as inputs to the second XOR gate 508. The output of the first XOR gate 506, R′, may correspond to the 16 LSB of the output of the FL function 408, FL_out. The output of the second XOR gate 508 may be utilized as an input to the second circular 1-bit shifter 510. The output of the second circular 1-bit shifter 510 and the signal L may be used as inputs to third XOR gate 512. The output of the third XOR 512, L′, may correspond to the 16 MSB of the output of the FL function 408, FL_out.

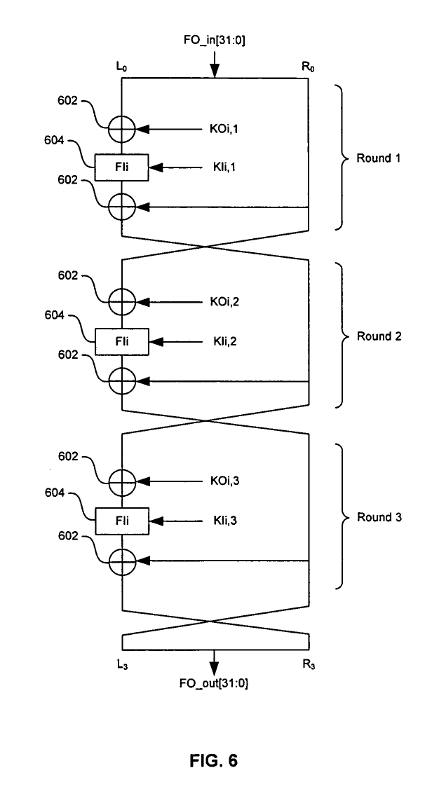

FIG. 6 is a flow diagram that illustrates a three-round FO function, which may be utilized in connection with an embodiment of the invention. Referring to FIG. 6, the FO function 412 in FIG. 4 may utilize a 32-bit data input, FO_in[31:0] and two sets of subkeys, namely a 48-bit subkey KOᵢ and 48-bit subkey KIᵢ. Each round of the three-round FO function 412 may comprise a bitwise XOR operation 602 and an FIi function 604, where the i^{th} index indicates the corresponding round in the eight-round KASUMI algorithm in FIG. 3. The bitwise XOR operation 602 may comprise suitable logic, circuitry, and/or code that may be adapted to perform a 16-bit XOR operation. The FIi function 604 may comprise suitable logic, circuitry, and/or code that may be adapted to perform the FI function in the KASUMI algorithm as specified by the 3GPP technical specification. The FIi function 604 may comprise four rounds of operations.

In operation, the 32-bit data input to the three-round FO function 412 may be split into two halves, L₀ and R₀, where L₀=FO_in[31:16] and R₀=FO_in[15:0]. The 48-bit subkeys are subdivided into three 16-bit subkeys where KOᵢ=KO_{i,1}∥KO_{i,2}∥KO_{i,3} and KIᵢ=KI_{i,1}∥KI_{i,2}∥KI_{i,3}. For each j^{th} round of the three-round FO function, where 1≦j≦3, the right and left inputs may be defined as Rⱼ=FI(Lⱼ₋₁⊕KO_{i,j}, KI_{i,j})⊕Rⱼ₋₁Lⱼ=Rⱼ₋₁, where FI( ) is the four-round FI function of the KASUMI algorithm. The FO function 412 produces a 32-bit output, FO_out[31:0], where FO_out[31:0]=L₃∥R₃.

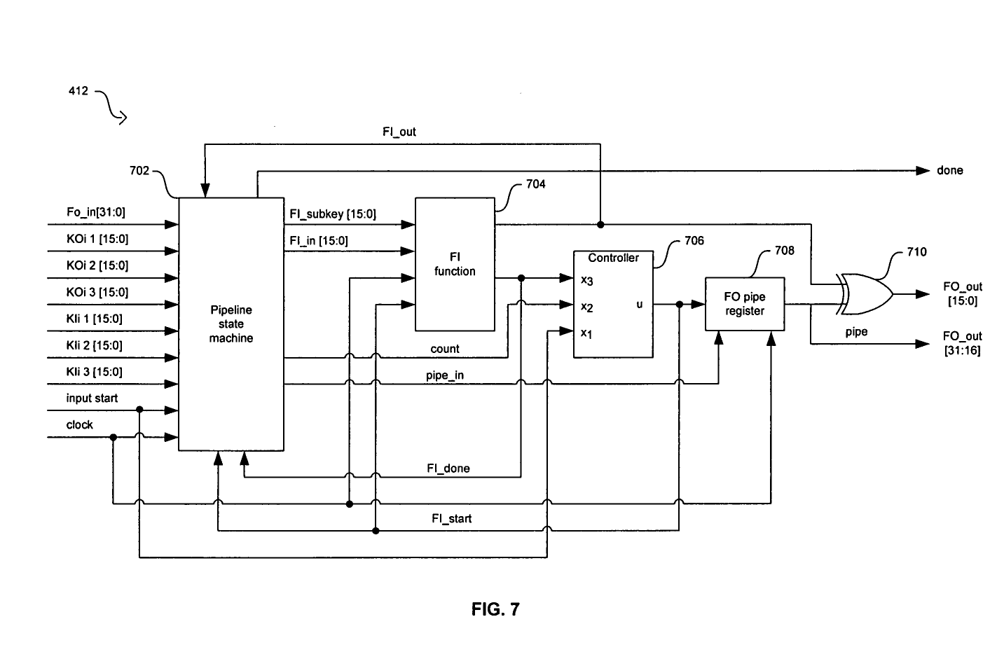

FIG. 7 is a block diagram of an exemplary implementation of the FO function, in accordance with an embodiment of the invention. Referring to FIG. 7, an implementation of the FO function 412 in FIG. 4 may comprise a pipeline state machine 702, an FI function 704, a controller 706, an FO pipe register 708, and an FO XOR operation 710. The pipeline state machine 702 may comprise suitable logic, circuitry, and/or code that may be adapted to control the flow of data and pipelining stages in each of the FO function rounds in the FO function 412. The FI function 704 may comprise suitable logic, circuitry, and/or code that may be adapted to perform the FI function of the KASUMI algorithm as specified by the 3GPP technical specifications. The controller 706 may comprise suitable logic, circuitry, and/or code that may be adapted to control the start of the FI function 704 and the clocking of data from the FO pipe register 708 to the FO XOR operation 710. The FO pipe register 708 may comprise suitable logic, circuitry, and/or code that may be adapted to store the 16 MSB of the output of the FO function 412, FO_out[31:16]. The FO XOR operation 710 may comprise suitable logic, circuitry, and/or code that may be adapted to produce the 16 LSB of the output of the FO function 412, FO_out[15:0].

The pipelined architecture of the FO function 412 illustrated in FIG. 7, may be utilized to minimize the number of logic cells needed to implement the FO function. The 16-bit subkeys KO_{i,1}, KO_{i,2}, KO_{i,3}, KI_{i,1}, KI_{i,2}, and KI_{i,3} that may be utilized as inputs to the pipelined state machine 702 may be generated by, for example, a key scheduler. A start signal may be provided by a top-level module or by an external source. The pipeline state machine 702 may be configured to generate the appropriate inputs to the FI function 704 depending on the pipelining stage. For example, the pipeline state machine 702 may generate the signal FI_in[15:0]=Lⱼ₋₁⊕KO_{i,j} for 1<=j<=3 and the corresponding 16-bit subkeys KI_{i,j} for 1<=j<=3.

The FI function 704 may generate a data output signal FI_out and an FI_done to indicate completion of its task. The FI_start signal may be generated by the controller 706 based on the count, start, and FI_done signals. The FI_start signal may be used to initiate the FI function 704. The start signal is input to FO function 412 to indicate the start of the FO function processing in the KASUMI algorithm. The count signal may be used to control the pipelined state machine 702 which controls the pipeline operation. The FI_done signal generated by FI function 704 may be used to indicate completion of its task. The FI_start signal may be represented in pseudo-code as FI_start=start OR ((count !=3) AND FI_done)).

When the FO function 412 processing is initiated by the start signal, the FI_start signal is high thus initiating the processing by the FI function 704 for the first time. Once FI function 704 completes its task, it may generate the FI_done signal. The FI_done signal may be utilized to generate the FI_start signal for next iteration. The count' signal may be monitored so that three applications or rounds of processing in the FI function 704 are achieved. The FI_out, FI_done and FI_start signals may be fed back to the pipelined state machine 702 to update the pipeline stages.

The outputs of the various pipeline stages may be stored in FO pipe register 708, and the pipelining process may be terminated at the end of the pipeline operation as indicated by the done signal generated by the pipeline state machine 702. At this time, the output of the FI function 704 may be given by FO_out[31:0].

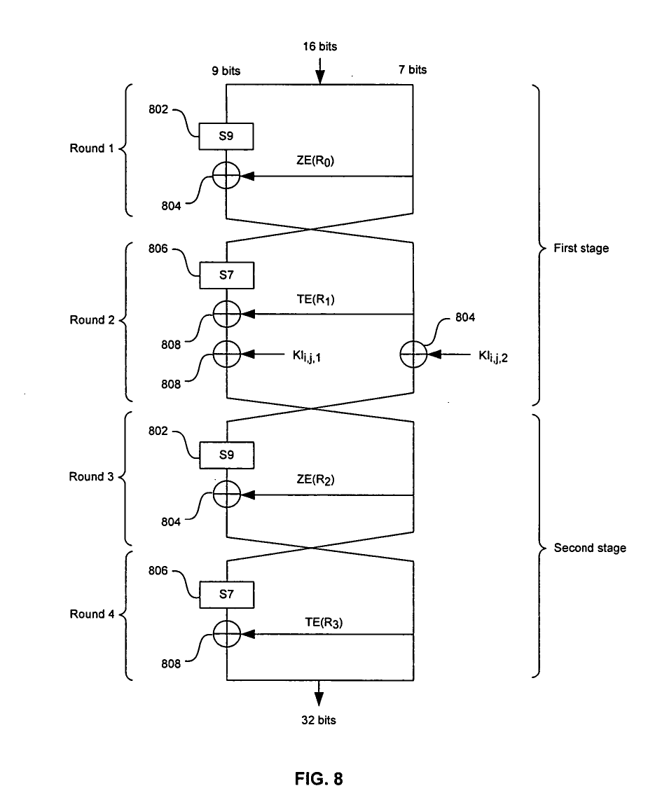

FIG. 8 is a flow diagram that illustrates a four-round FI function, which may be utilized in connection with an embodiment of the invention. Referring to FIG. 8, the FI function 704 in FIG. 7 may operate on a 16-bit input FI_in[15:0] with a 16-bit subkey KI_{i,j}, where the i^{th} and j^{th} indices correspond to the current KASUMI and FO function rounds respectively. The input FI_in[15:0] may be split into two unequal components, a 9-bit left half L₀=FI_in[15:7] and a 7-bit right half R₀=FI_in[6:0] where FI_in[15:0]=L₀∥R₀. Similarly the subkey KI_{i,j} may be split into a 7-bit component KI_{i,j,1} and a 9-bit component KI_{i,j,2}, where KI_{i,j}=KI_{i,j,1}∥KI_{i,j,2}.

The FI function 704 may comprise four rounds of operations, where the first two rounds may correspond to a first stage of the FI function and the last two rounds may correspond to a second stage of the FI function. The FI function 704 may comprise a 9-bit substitution box (S9) 802, a 7-bit substitution box (S7) 806, a plurality of 9-bit XOR operations 804, and a plurality of 7-bit XOR operations 808. The S9 802 may comprise suitable logic, circuitry, and/or code that may be adapted to map a 9-bit input signal to a 9-bit output signal. The S7 806 may comprise suitable logic, circuitry, and/or code that may be adapted to map a 7-bit input signal to a 7-bit output signal. The 9-bit XOR operation 804 may comprise suitable logic, circuitry, and/or code that may be adapted to provide a 9-bit output for an XOR operation between two 9-bit inputs. The 7-bit XOR operation 808 may comprise suitable logic, circuitry, and/or code that may be adapted to provide a 7-bit output for an XOR operation between two 7-bit inputs.

In operation, the first round of the FI function 704 may generate the outputs L₁=R₀ and R₁=S9[L₀]⊕ZE(R₀), where ⊕ represents the 9-bit XOR operation 804, S9[L₀] represents the operation on L₀ by the S9 802, and ZE(R₀) represents a zero-extend operation that takes the 7-bit value R₀ and converts it to a 9-bit value by adding two zero (0) bits to the most significant end or leading end. The second round of the FI function 704 may generate the output R₂=S7[L₁]⊕TR(R₁)⊕KI_{i,j,1}, where ⊕ represents the 7-bit XOR operation 808, S7[L₁] represents the operation on L₁ by the S7 806, and TE(R₁) represents a truncation operation that takes the 9-bit value R₁ and converts it to a 7-bit value by discarding the two most significant bits. The second round of the FI function 704 may also generate the output L₂=R₁⊕KI_{i,j,2}, where ⊕ represents the 9-bit XOR operation 804. The first pipelined stage of operation of the FI function 704 comprises the operations in the first and second rounds of the FI function 704.

The third round of the FI function 704 may generate the outputs L₃=R₂ and R₃=S9[L₂]⊕ZE(R₂), where ⊕ represents the 9-bit XOR operation 804, S9[L₂] represents the operation on L₂ by the S9 802 and ZE(R₂) represents a zero-extend operation that takes the 7-bit value R₂ and converts it to a 9-bit value by adding two zero bits to the most significant end or leading end. The fourth round of the FI function 704 may generate the outputs L₄=S7[L₃]⊕TE(R₃) and R₄=R₃, where ⊕ represents the 7-bit XOR operation 808, S7[L₃] represents the operation on L₃ by the S7 806 and TE(R₃) represents a truncation operation that takes the 9-bit value R₃ and converts it to a 7-bit value by discarding the two most significant bits. The second pipelined stage of operation of the FI function 704 comprises the operations in the third and fourth rounds of the FI function 704. The output of the FI function 704, FI_out[15:0], is a 16-bit value that corresponds to L₄∥R₄, where L₄=FI_out[15:7] and R₄=FI_out[6:0].

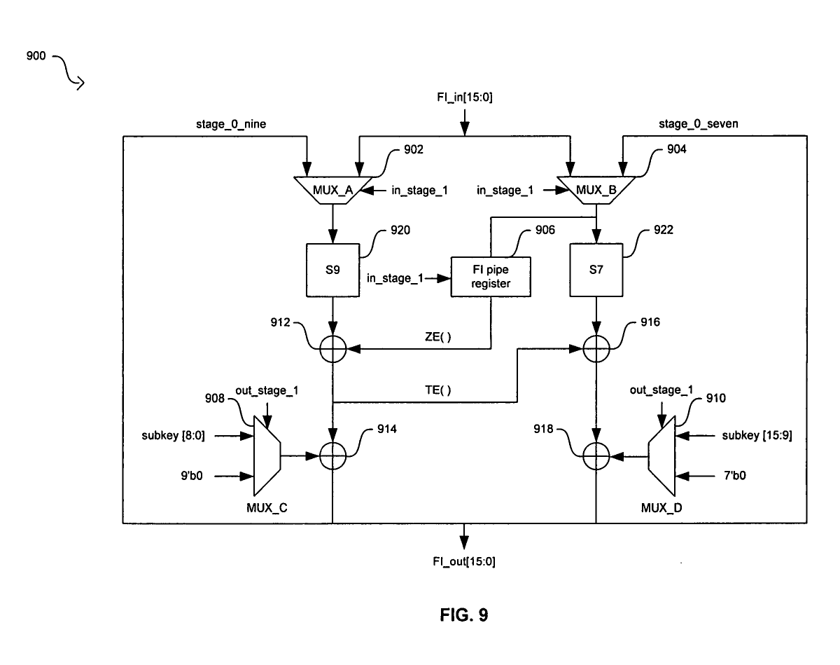

FIG. 9 is a circuit diagram of an exemplary implementation of the FI function, in accordance with an embodiment of the invention. Referring to FIG. 9, a pipelined implementation 900 of the FI function 704 in FIG. 7 may comprise a MUX_A multiplexer 902, a MUX_B multiplexer 904, a MUX_C multiplexer 908, a MUX_D multiplexer 910, an S9 920, an S7 922, a first 9-bit XOR gate 912, a second 9-bit XOR gate 914, a first 7-bit XOR gate 916, a second 7-bit XOR gate 918, and an FI pipe register 906. The S9 920 may correspond to the S9 802 in FIG. 8 and may comprise suitable logic, circuitry, and/or code that may be adapted to map a 9-bit input signal to a 9-bit output signal. The S7 922 may correspond to the S7 806 in FIG. 8 and may comprise suitable logic, circuitry, and/or code that may be adapted to map a 7-bit input signal to a 7-bit output signal. The first 9-bit XOR gate 912 and the second 9-bit XOR gate 914 may correspond to the 9-bit XOR operation 804 in FIG. 8 and may comprise suitable logic, circuitry, and/or code that may be adapted to provide a 9-bit output for an XOR operation between two 9-bit inputs. The first 7-bit XOR gate 916 and the second 7-bit XOR gate 918 may correspond to the 7-bit XOR operation 808 in FIG. 8 and may comprise suitable logic, circuitry, and/or code that may be adapted to provide a 9-bit output for an XOR operation between two 9-bit inputs.

The MUX_A multiplexer 902 may comprise suitable logic, circuitry, and/or code that may be adapted to select the input to the S9 920 according to whether it is the first pipelined stage or second pipelined stage of operation of the FI function 704. The selection may be controlled by a pipeline signal in_stage_1 signal. The MUX_B multiplexer 904 may comprise suitable logic, circuitry, and/or code that may be adapted to select the input to the S7 922 according to whether it is the first pipelined stage or second pipelined stage of operation of the FI function 704. The selection may be controlled by the pipeline signal in_stage_1 signal. The MUX_C multiplexer 908 may comprise suitable logic, circuitry, and/or code that may be adapted to select the input to the second 9-bit XOR gate 914 according to whether it is the first stage or second stage of the FI function 704. The selection may be controlled by a pipeline signal out_stage_1 signal. The MUX_D multiplexer 910 may comprise suitable logic, circuitry, and/or code that may be adapted to select the input to the second 7-bit XOR gate 918 according to whether it is the first stage or second stage of the FI function 704. The selection may be controlled by the pipeline signal out_stage_1 signal.

The S9 920 and the S7 922 may be implemented, for example, as combinational logic or as at least one look-up table. For example, the S7 922 may be implemented as a look-up table using a synchronous 128×7 Read Only Memory (ROM), in which 7-bits may be utilized for addressing 128 locations, while the S9 920 may be implemented using a synchronous 512×9 ROM, in which 9-bits may be utilized for addressing 512 locations. The FI pipe register 906 may comprise suitable logic, circuitry, and/or code that may be adapted to store the input to the 7-bit substitution box 922, zero extend the stored input, and transfer the zero-extended stored input to the first 9-bit XOR gate 912. The storage and transfer may be based on the pipeline signal in_stage_1.

In operation, the inputs to the FI function 704 are the 16-bit data input FI_in[15:0], a 16-bit subkey FI_subkey[15:0], and the FI_start signal from the controller 706 in FIG. 7. The pipelined implementation 900 is synchronous and clocking may be provided by the clock signal shown in FIG. 7. In the first pipelined stage of operation, the FI_start signal may be held high for one clock cycle. The pipeline signal in_stage_1, which may be a single clock cycle delayed version of the FI_start signal, may be adapted so that it lags the FI_start signal. The inputs to S9 920 and S7 922 are FI_in[15:7] and FI_in[6:0] respectively. On the next clock cycle, which corresponds to the second pipelined stage of operation, the pipeline signal in_stage_1 is high and the inputs to S9 920 and S7 922 are the stage_0_nine signal and stage_0_seven signal respectively.

The pipeline signal out_stage_1 may be a single clock cycle delayed version of the pipeline signal in_stage_1 signal, and may be utilized to select the subkeys subkey[8:0] and subkey[15:9]. When the pipeline signal out_stage_1 is low, the subkeys subkey[8:0] and subkey[15:9] may be selected in MUX_C multiplexer 908 and MUX_D multiplexer 910 respectively for the first pipelined stage of the pipeline process. On the second and final pipelined stage of the pipeline process, the subkeys are not utilized, and zeros values of appropriate bit lengths, namely 9-bit for XORing with the second 9-bit XOR gate 914 and 7-bit for XORing with the second 7-bit XOR gate 918 may be selected. An FI_done signal may be generated by the FI function 704 to indicate completion of the pipelined process. This FI_done signal may be generated using pipeline signal out_stage_1.

The KASUMI algorithm has a 128-bit key K and each of the eight rounds of the KASUMI algorithm, and the corresponding FO, FI, and FL functions, may utilize 128 bits of key derived from K. To determine the round subkeys, two arrays of eight 16-bit subkeys, Kⱼ and Kⱼ′, where j=1 to 8, may be derived. The first array of 16-bit subkeys K₁ through K₈ is such that K=K₁∥K₂∥K₃∥ . . . ∥K₈. The second array of subkeys may be derived from the first set of subkeys by the expression Kⱼ′=Kⱼ⊕Cⱼ, where Cⱼ is a constant 16-bit value that may be defined in hexadecimal as: C₁=0×0123, C₂=0×4567, C₃=0×89AB, C₄=0×CDEF, C₅=0×FEDC, C₆=0×BA98, C₇=0×7654, and C₈=0×3210.

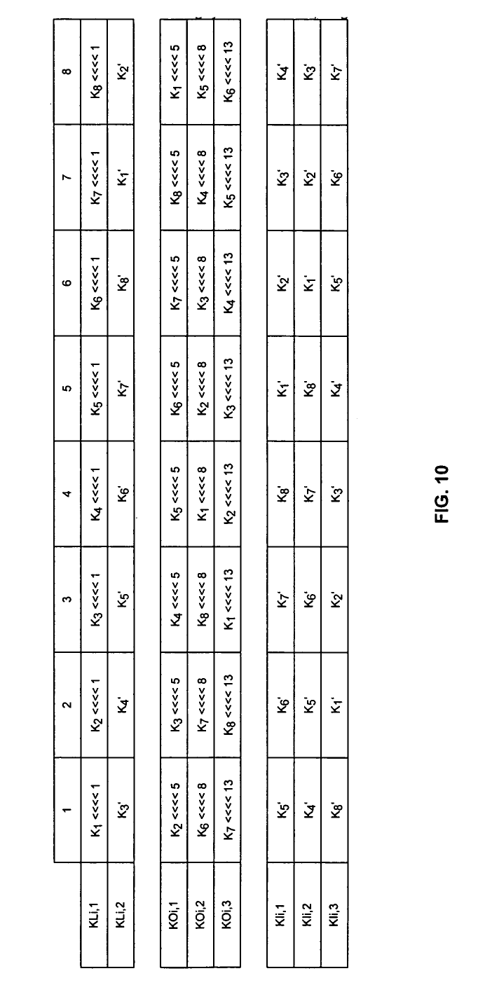

FIG. 10 illustrates the round subkeys generated by a key scheduler from the arrays of subkeys Kⱼ and Kⱼ′ for the eight-round KASUMI algorithm, in accordance with an embodiment of the invention. Referring to FIG. 10, a key scheduler may comprise suitable logic, circuitry, and/or code that may be adapted to generate the subkey triplet KLᵢ, KOᵢ, and KIᵢ required for the KASUMI algorithm from the two arrays of subkeys Kⱼ and Kⱼ′. Because the KASUMI algorithm, the FO function, and the FI function are pipelined, one round of the KASUMI algorithm may be repeated eight times to achieve reduction in power and IC area. The subkey triplet KLᵢ, KOᵢ, and KIᵢ may be further divided into KLᵢ=KL_{i,1}∥KL_{i,2}, KOᵢ=KO_{i,1}∥KO_{i,2}|KO_{i,3}, and KIᵢ=KI_{i,1}∥KI_{i,2}∥KI_{i,3}. The 16-bit rotations shown in FIG. 10 that may be utilized to obtain the subkeys, may be implemented with, for example, shift registers and/or combinational logic.

In accordance with an embodiment of the invention, the KASUMI algorithm may be efficiently implemented in hardware by utilizing the pipelined architecture of the KASUMI algorithm system 400. Accordingly, the pipelined implementation of the KASUMI algorithm system 400 provides a cost effective and efficient implementation that accelerates cryptographic operations in GSM/GPRS/EDGE compliant handsets.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for accelerating cryptography operations, the method comprising:
selecting via a first selector a first portion of input data;
transferring said first portion of input data to a first pipe register;
selecting via a second selector a second portion of input data;
transferring said second portion of input data to a second pipe register;
enabling a third selector to transfer said transferred first portion of said input data to an FL function for processing during odd rounds or to transfer an output of an FO function to said FL function for processing during even rounds; and
enabling a fourth selector to transfer said transferred first portion of said input data to said FO function for processing during even rounds or to transfer an output of said FL function to said FO function for processing during odd rounds.

2. The method according to claim 1, further comprising enabling a fifth selector to select said output of said FO function during odd rounds or to select said output of said FL function during even rounds.

3. The method according to claim 2, further comprising generating a first output signal by XORing an output of said fifth selector with said transferred second portion of said input data.

4. The method according to claim 3, further comprising transferring said first output signal to an input of said first selector.

5. The method according to claim 1, further comprising transferring a second output signal to an input of said second selector, wherein said second output signal is said transferred second portion of said input data.

6. The method according to claim 1, further comprising controlling said first selector and said second selector via a first control signal and a second control signal.

7. The method according to claim 6, further comprising clocking said first portion of said input data and said second portion of said input data into said first pipe register and said second pipe register respectively using said first control signal.

8. The method according to claim 7, further comprising generating said second control signal when said output of said FO function is available for processing.

9. The method according to claim 1, further comprising controlling said third selector, said fourth selector and a fifth selector via a third control signal.

10. The method according to claim 9, further comprising generating said third control signal based on whether the round is odd or even.

11. The method according to claim 1, further comprising transferring a first set of subkeys to said FL function for processing with an output of said third selector.

12. The method according to claim 1, further comprising transferring a second set of subkeys to said FO function for processing with an output of said fourth selector.

13. A system for accelerating cryptography operations, the system comprising:
a first selector that selects a first portion of input data;
a first pipe register that stores said first portion of input data after said first portion of said input data is transferred from said first selector;
a second selector that selects a second portion of input data;
a second pipe register that stores said second portion of input data after said second portion of said input data is transferred from said second selector;
a third selector that transfers said transferred first portion of said input data to an FL function for processing during odd rounds or that transfers an output of an FO function to said FL function for processing during even rounds; and
a fourth selector that transfers said transferred first portion of said input data to said FO function for processing during even rounds or that transfers an output of said FL function to said FO function for processing during odd rounds.

14. The system according to claim 13, wherein a fifth selector selects said output of said FO function during odd rounds or selects said output of said FL function during even rounds.

15. The system according to claim 14, wherein an XOR gate generates a first output signal by XORing an output of said fifth selector with said transferred second portion of said input data.

16. The system according to claim 15, further comprising circuitry for transferring said first output signal to an input of said first selector.

17. The system according to claim 13, further comprising circuitry for transferring a second output signal to an input of said second selector, wherein said second output signal is said transferred second portion of said input data.

18. The system according to claim 13, wherein said first selector and said second selector are controlled via a first control signal and a second control signal.

19. The system according to claim 18, further comprising circuitry for clocking said first portion of said input data and said second portion of said input data into said first pipe register and said second pipe register respectively using said first control signal.

20. The system according to claim 19, further comprising circuitry for generating said second control signal, wherein said second control signal is generated when said output of said FO function is available for processing.

21. The system according to claim 13, wherein said third selector, said fourth selector and a fifth selector are controlled via a third control signal.

22. The system according to claim 21, further comprising circuitry for generating said third control signal based on whether the round is odd or even.

23. The system according to claim 13, further comprising circuitry for transferring a first set of subkeys to said FL function for processing with an output of said third selector.

24. The system according to claim 13, further comprising circuitry for transferring a second set of subkeys to said FO function for processing with an output of said fourth selector.
